(19) United States
(12) Patent Application Publication
(10) Pub. No.: US 2010/0042971 A1
(43) Pub. Date: Feb. 18, 2010

(54) SYSTEM AND METHOD FOR CALLING AN UN-PREDETERMINED SUBROUTINE IN A COMPUTER PROGRAM

(75) Inventors: CHANG-GEN FANG, Shenzhen City (CN); FENG LIU, Shenzhen City (CN); BO LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD, Shenzhen City (CN); HON HAI PRECISION INDUSTRY CO., LTD., Tu-Cheng (TW)

(21) Appl. No.: 12/535,795

(22) Filed: Aug. 5, 2009

(30) Foreign Application Priority Data
Aug. 14, 2008 (CN) 200810303762.3

(51) Int. Cl. G06F 9/44

(52) U.S. Cl. 717/106

(57) ABSTRACT

A method for calling an un-predetermined subroutine in a computer program receives a subroutine name and parameter values of the subroutine. The method determines input parameters and output parameters of the subroutine. Multiple blocks of program codes are generated for transmitting the parameter values to the subroutine, executing the subroutine, and outputting an executed result returned from the subroutine to the computer program. The blocks of program codes are sequentially executed, so that the subroutine is indirectly called in the computer program.

### BACKGROUND

1. Technical Field

Embodiments of the present disclosure relate to computer programming, and particularly to a system and method for calling an un-predetermined subroutine in a computer program.

2. Description of Related Art

A subroutine is a block of program codes that deals with a particular task. Generally speaking, a computer program can call a certain subroutine by a subroutine name of the subroutine, along with parameter values passed to the subroutine. However, it may be uncertain which subroutine to be called in a computer program at design time. Therefore, the subroutine name and the parameters of the subroutine are unknown. In this case, the un-predetermined subroutine cannot be called in a normal way.

### BRIEF DESCRIPTION OF THE DRAWINGS

FIG. 1 is a block diagram of one embodiment of a system for calling an un-predetermined subroutine in a computer program.

FIG. 2 is a flowchart of one embodiment of a method for calling an un-predetermined subroutine in a computer program.

FIG. 3 illustrates one embodiment of a second parameter of a parameter interface.

### DETAILED DESCRIPTION

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

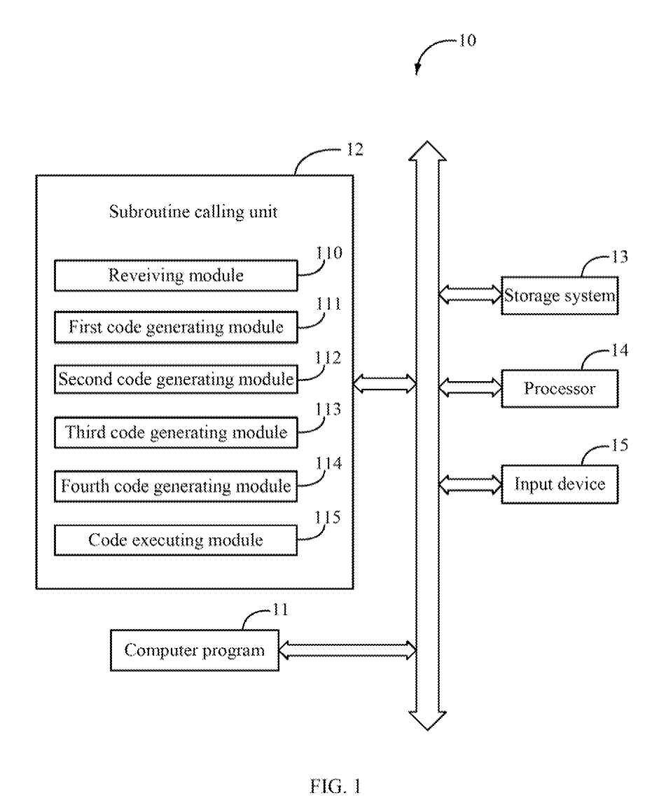

FIG. 1 is a block diagram of one embodiment of a system 10 for calling an un-predetermined subroutine in a computer program 11. The system 10 may include a subroutine calling unit 12, a storage system 13, a processor 14, and an input device 15. One or more computerized codes of the subroutine calling unit 12 and the computer program 11 may be stored in the storage system 13 and executed by the processor 14. The components 11-14 of the system 10 are in data communication via one or more standards-based bus system. It may be understood that which subroutine to be called in a computer program may be uncertain at design time. Such a subroutine is called an un-predetermined subroutine. In one example, a computer program may call a subroutine. The subroutine may be a function “A,” a function “B,” or a function “C.” The decision to call which subroutine may be uncertain until runtime of the computer program. By implementing the system 10, any desired subroutine, such as the function “A,” the function “B,” and the function “C” can be called in the computer program. The input device 15 may be a mouse or a keyboard. In one embodiment, the system 10 may be applied in an enterprise resource planning system.

In one embodiment, the subroutine calling unit 12 may include a receiving module 110, a first code generating module 111, a second code generating module 112, a third code generating module 113, a fourth code generating module 114, and a code executing module 115.

The receiving module 110 is operable to receive a subroutine name and one or more parameter values of the subroutine from the input device 15. The receiving module 110 is further operable to determine one or more input parameters and one or more output parameters of the subroutine according to the subroutine name. It may be understood that input parameters are used to pass values to the subroutine. Output parameters are used to return values from the subroutine.

The first code generating module 111 is operable to generate a first block of program codes. The first block of program codes may be executable by the processor 14 to declare an input variable for each of the one or more input parameters and an output variable for each of the one or more output parameters. The input variables and the output variables may be different for different subroutines. The first code generating module 111 is further operable to store the first block of program codes into the storage system 13.

The second code generating module 112 is operable to generate a second block of program codes. The second block of program codes may be executable by the processor 14 to assign a value to each of the one or more input variables according to the one or more parameter. The second code generating module 112 is further operable to store the second block of program codes into the storage system 13.

The third code generating module 113 is operable to generate a third block of program codes. The third block of program codes may be executable by the processor 14 to execute the subroutine and return an executed result from the subroutine. The third block of program codes may execute the subroutine by passing the one or more input variables to the subroutine as actual input parameters, and pass the one or more output variables to the subroutine as actual output parameters. The executed result may be returned from the subroutine via the one or more output variables. The third code generating module 113 is further operable to store the third block of program codes into the storage system 13.

The fourth code generating module 114 is operable to generate a fourth block of program codes. The fourth block of program codes may be executable by the processor 14 to output the executed result to the computer program 11. The fourth code generating module 114 is further operable to store the fourth block of program codes into the storage system 13.

The code executing module 115 is operable to sequentially execute the first block of program codes, the second block of program codes, the third block of program codes, and the fourth block of program codes. The input variable for each of the one or more input parameters and the output variable for each of the one or more output parameter are declared when the first block of program codes is executed. A value is assigned to each of the one or more input variables according to the one or more parameter when the second block of program codes is executed. The subroutine is executed by passing the one or more input variables and the one or more output variables to the subroutine when the third block of program codes is executed. The executed result is returned from the subroutine. The executed result is then output to the computer program 11 when the fourth block of program codes is executed.

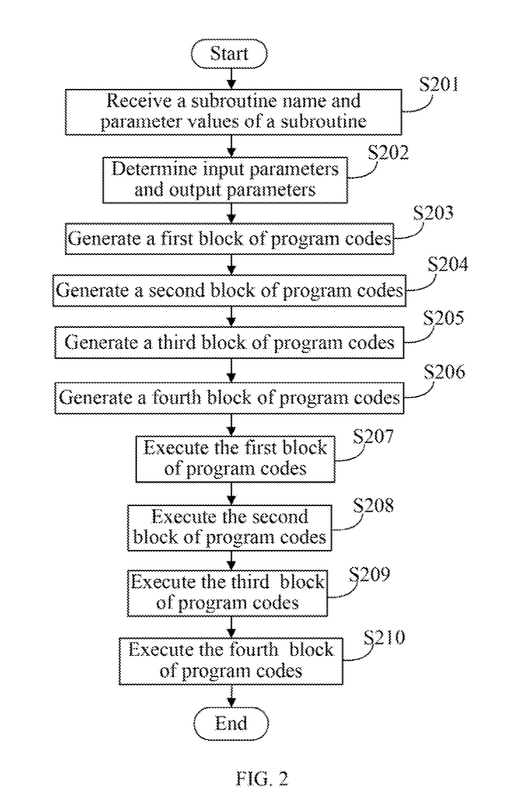

FIG. 2 is a flowchart of one embodiment of a method for calling an un-predetermined subroutine in a computer program 11 of FIG. 1. Any subroutine that contains any number of parameters may be called in the computer program 11 by implementing the method. Depending on the embodiments, additional blocks may be added, others removed, and the ordering of the blocks may be changed.

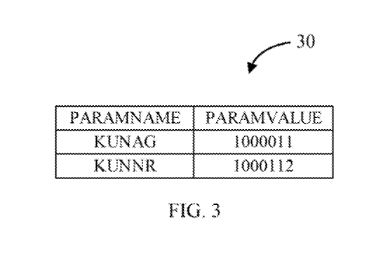

In block S201, the receiving module 110 receives a subroutine name and one or more parameter values of the subroutine from the input device 15. In one embodiment, the receiving module 110 may receive the subroutine name and the parameter values via a parameter interface. The parameter interface may include one or more parameters. In one example, the parameter interface includes a first parameter to receive the subroutine name, such “FUNC1.” The parameter interface includes a second parameter, such as a second parameter 30 shown in FIG. 3, to receive the parameter values, such as “1000011” and “1000112”.

In block S202, the receiving module 110 determines one or more input parameters and one or more output parameters of the subroutine according to the subroutine name. For example, the receiving module 110 may determine input parameters “KUNAG” and “KUNNR” of the subroutine “FUNC1.” The receiving module 110 further determines an output parameter “BSTKD” of the subroutine “FUNC1.”

In block S203, the first code generating module 111 generates a first block of program codes, and stores the first block of program codes into the storage system 13. The first block of program codes may be executable by the processor 14 to declare an input variable for each of the one or more input parameters and an output variable for each of the one or more output parameters. For example, the first block of program codes may declare an input variable “L_KUNAG” for the input parameter “KUNAG,” and declare an input variable “L_KUNNR” for the input parameter “KUNNR.” The first block of program codes may declare an output variable “L_BSTKD” for the output parameter “BSTKD.”

In block S204, The second code generating module 112 generates a second block of program codes, and stores the second block of program codes into the storage system 13. The second block of program codes may be executable by the processor 14 to assign a value to each of the one or more input variables according to the one or more parameter values. For example, the second block of program codes may assign the parameter value “1000011” to the input variable “L_KUNAG,” and assign the parameter value “1000112” to the input variable “L_KUNNR.”

In block S206, the third code generating module 113 generates a third block of program codes, and stores the third block of program codes into the storage system 13. The third block of program codes may be executable by the processor 14 to execute the subroutine and return an executed result from the subroutine. The subroutine may be executed by passing the one or more input variables to the subroutine as actual input parameters, and by passing the one or more output variables to the subroutine as actual output parameters. Therefore, the executed result may be returned from the subroutine via the one or more output variables. For example, the input variables “L_KUNAG” and “L_KUNNR” may be passed to the subroutine “FUNC1” as actual input parameters. The output variable “L_BSTKD” may be passed to the subroutine “FUNC1” as an actual output parameter. The executed result may be returned from the subroutine “FUNC1” via the output variable “L_BSTKD.”

In block S206, the fourth code generating module 114 generates a fourth block of program codes, and stores the fourth block of program codes into the storage system 13. The fourth block of program codes may be executable by the processor 14 to output the executed result to the computer program 11. In one embodiment, the executed result is output via the parameter interface. For example, the parameter interface includes a third parameter. A value of the output variable “L_BSTKD” is assigned to the third parameter.

In block S207, the code executing module 115 executes the first block of program codes. Therefore, the input variable for each of the one or more input parameters and the output variable for each of the one or more output parameter are declared. In one example, the code executing module 115 declares an input variable “L_KUNAG” for the input parameter “KUNAG” and an input variable “L_KUNNR” for the input parameter “KUNNR.” The code executing module 115 further declares an output variable “L_BSTKD” for the output parameter “BSTKD.”

In block S208, the code executing module 115 executes the second block of program codes. Therefore, a value is assigned to each of the one or more input variables according to the one or more parameter values. In one example, the code executing module 115 assigns the parameter value “1000011” to the input variable “L_KUNAG” and assigns the parameter value “1000112” to the input variable “L_KUNNR.”

In block S209, the code executing module 115 executes the third block of program codes. Therefore, the subroutine is executed and the executed result is returned from the subroutine. In one example, the code executing module 115 passes the input variables “L_KUNAG” and “L_KUNNR” to the subroutine “FUNC1” as the actual input parameters. The code executing module 115 passes the output variable “L_BSTKD” to the subroutine “FUNC1” as the actual output parameter. The executed result is returned from the subroutine “FUNC1” via the output variable “L_BSTKD.”

In block S210, the code executing module 115 executes the fourth block of program codes. Therefore, the executed result that is returned from the subroutine is output to the computer program 11. In one example, the code executing module 115 assigns the value of the output variable “L_BSTKD” to the third parameter of the parameter interface. As such, the computer program 11 obtains the executed result.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for calling an un-predetermined subroutine in a computer program, the system comprising:
a storage system;
at least one processor; and
a subroutine calling unit stored in the storage system and being executable by the at least one processor, the subroutine calling unit comprising:
a receiving module to receive a subroutine name and one or more parameter values of the subroutine from an input device, and determine one or more input parameters and one or more output parameters of the subroutine according to the subroutine name;
a first code generating module to generate a first block of program codes being executable by the at least one processor to declare an input variable for each of the one or more input parameters, declare an output variable for each of the one or more output parameters, and store the first block of program codes into the storage system;
a second code generating module to generate a second block of program codes being executable by the at least one processor to assign the one or more parameter values to the one or more input variables, and store the second block of program codes into the storage system;
a third code generating module to generate a third block of program codes being executable by the at least one processor to execute the subroutine and return an executed result from the subroutine by passing the one or more input variables to the subroutine as actual input parameters and passing the one or more output variables to the subroutine as actual output parameters, and store the third block of program codes into the storage system;
a fourth code generating module to generate a fourth block of program codes being executable by the at least one processor to output the executed result to the computer program, and store the fourth block of program codes into the storage system; and
a code executing module to sequentially execute the first block of program codes, the second block of program codes, the third block of program codes, and the fourth block of program codes.

2. The system of claim 1, wherein the receiving module receives the subroutine name and the one or more parameter values of the subroutine via a parameter interface.

3. The system of claim 2, wherein the executed result returned from the subroutine is output via the parameter interface.

4. The system of claim 1, wherein the input variables and the output variables are different for different subroutines.

5. The system of claim 1, wherein the system is applied in an enterprise resource planning system.

6. A computer-implemented method for calling an un-predetermined subroutine in a computer program, the method comprising:
receiving a subroutine name and one or more parameter values of the subroutine from an input device;
determining one or more input parameters and one or more output parameters of the subroutine according to the subroutine name;
generating a first block of program codes being executable to declare an input variable for each of the one or more input parameters and an output variable for each of the one or more output parameters, and storing the first block of program codes into a storage system;
generating a second block of program codes being executable to assign the one or more parameter values to the one or more input variables, and storing the second block of program codes into the storage system;
generating a third block of program codes being executable to execute the subroutine and return an executed result from the subroutine by passing the one or more input variables to the subroutine as actual input parameters and passing the one or more output variables to the subroutine as actual output parameters, and storing the third block of program codes into the storage system;
generating a fourth block of program codes being executable to output the executed result to the computer program, and storing the fourth block of program codes into the storage system; and
sequentially executing the first block of program codes, the second block of program codes, the third block of program codes, and the fourth block of program codes to output the executed result to the computer program.

7. The method of claim 6, wherein the subroutine name and the one or more parameter values of the subroutine are received via a parameter interface.

8. The method of claim 7, wherein the executed result returned from the subroutine is output via the parameter interface.

9. The method of claim 6, wherein the input variables and the output variables are different for different subroutines.

10. The method of claim 6, wherein the method is applied in an enterprise resource planning system.

11. A computer-readable medium having stored thereon instructions that, when executed by a computerized device, cause the computerized device to execute a computer-implemented method for calling an un-predetermined subroutine in a computer program, the method comprising:
receiving a subroutine name and one or more parameter values of the subroutine from an input device;
determining one or more input parameters and one or more output parameters of the subroutine according to the subroutine name;
generating a first block of program codes being executable to declare an input variable for each of the one or more input parameters and an output variable for each of the one or more output parameters, and storing the first block of program codes into a storage system;
generating a second block of program codes to assign the one or more parameter values to the one or more input variables, and storing the second block of program codes into the storage system;
generating a third block of program codes being executable to execute the subroutine and return an executed result from the subroutine by passing the one or more input variables to the subroutine as actual input parameters and passing the one or more output variables to the subroutine as actual output parameters, and storing the third block of program codes into the storage system;
generating a fourth block of program codes being executable to output the executed result to the computer program and storing the fourth block of program codes into the storage system; and
sequentially executing the first block of program codes, the second block of program codes, the third block of program codes, and the fourth block of program codes to output the executed result to the computer program.

12. The medium of claim 11, wherein the subroutine name and the one or more parameter values of the subroutine are received via a parameter interface.

13. The medium of claim 12, wherein the executed result returned from the subroutine is output via the parameter interface.

14. The medium of claim 11, wherein the input variables and the output variables are different for different subroutines.

15. The medium of claim 11, wherein the method is applied in an enterprise resource planning system.
